(19) United States
(12) Patent Application Publication
(10) Pub. No.: US 2026/0358549 A1
(43) Pub. Date: Nov. 12, 2026

(54) CONTROL OF AG INK FLOW VIA INKJET REMOVABLE MASK FOR AR DEVICES

(71) Applicant: Applied Materials, Inc., Santa Clara, CA (US)

(72) Inventors: Yingdong LUO, Newark, CA (US); Marco GALIAZZO, Quinto Di Treviso (IT); Zhengping YAO, Cupertino, CA (US); Daihua ZHANG, Los Altos, CA (US); Xiaopei DENG, San Jose, CA (US); Rami HOURANI, Santa Clara, CA (US); Ludovic GODET, Sunnyvale, CA (US)

(21) Appl. No.: 19/128,553

(22) PCT Filed: Nov. 27, 2023
(86) PCT No.: PCT/US2023/081164

§ 371 Date: May 8, 2025

Related U.S. Application Data
(60) Provisional application No. 63/385,247, filed on Nov. 29, 2022.

(51) Int. Cl. F21V 8/00

(52) U.S. Cl. CPC G02B 6/0065; G02B 6/0036; G02B 6/0055

(57) ABSTRACT

A method and apparatus for forming a device, including depositing a mask layer on a first portion of a surface, the mask layer forming a feature over the surface, depositing the mirror layer on the second portion of the surface within the feature, and removing the mask layer from the surface.

### BACKGROUND

### Field

Embodiments of the present disclosure generally relate to waveguides and methods for fabricating waveguides.

### Description of the Related Art

In waveguide devices, such as a virtual reality (VR) device or an augmented reality (AR) device, a waveguide combiner is often used to couple a virtual image, transport light inside a glass substrate through total internal reflection, and then couple the image when reaching the position of viewer's eye. For light coupling and decoupling, slanted features and trenches in the waveguide combiner are usually applied as gratings for light diffraction. The orientation of lines (fins) controls the light propagation direction, whereas the tilted angle controls the efficiency of desired orders of diffraction. Mirrors are used to reflect the light on a controlled manner.

In many applications, mirrors having silver layers are used in these waveguide devices. To protect the silver from long term oxidation, an encapsulation layer is often deposited on or over the silver layer. However, when the silver layer is exposed to an oxidizing environment, such as oxygen in a plasma reactor, the silver atoms often migrate into neighboring layers and or the substrate damaging the waveguide device. Migration is especially a problem to silicon oxide layers as well as glass or quartz substrates or wafers.

Therefore, there is a need for improved waveguides and methods for fabricating waveguides.

### SUMMARY

The present disclosure generally relates to a method for forming a device. The method may include depositing a mask layer on a first portion of a surface, the mask layer forming a feature over the surface. The method may include depositing the mirror layer on the second portion of the surface within the feature. The method may include removing the mask layer from the surface.

The present disclosure generally relates to a mask layer. The mask layer may include a composition disposed on a portion of a surface, the composition capable of forming a feature over the surface. In one example, the composition may include an organic polymer, a photo curable component, a solvent, and additives.

The present disclosure generally relates to a device. The device may include a mask layer deposited on a first portion of a surface, the mask layer forming a feature over the surface, and the mirror layer deposited on the second portion of the surface within the feature.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1A depicts a perspective, frontal view of a waveguide, according to one or more embodiments described and discussed herein.

FIG. 1B depicts a schematic cross-sectional view of a waveguide device, according to one or more embodiments described and discussed herein.

FIG. 1C depicts a schematic cross-sectional view of a waveguide device, according to one or more embodiments described and discussed herein.

FIG. 2 depicts a is a flow diagram of a method for forming a waveguide.

FIGS. 3A-3G depicts a schematic cross-sectional view of a waveguide, according to one or more embodiments described and discussed herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to encapsulated waveguides and methods for fabricating the encapsulated waveguides. The waveguide may be used in virtual reality (VR) devices, augmented reality (AR) devices, as well as other devices, including optical devices, display devices, and/or microelectronic devices.

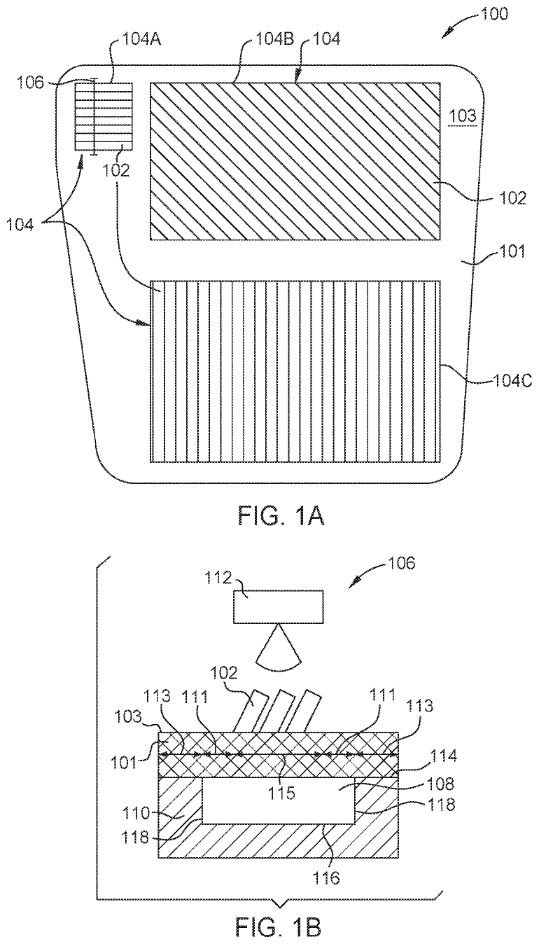

FIG. 1A is a perspective, frontal view of a waveguide 100. It is to be understood that the waveguide 100 described herein is an exemplary waveguide and that other waveguides may be used with or modified to accomplish aspects of the present disclosure. The waveguide 100 includes a plurality of structures 102. The structures 102 may be disposed over, under, or on a first surface 103 of a substrate 101, or disposed in the substrate 101. The structures 102 are nanostructures have a sub-micron critical dimension, e.g., a width less than 1 micrometer. Regions of the structures 102 correspond to one or more gratings 104. In one embodiment, which can be combined with other embodiments described herein, the waveguide 100 includes at least a first grating 104a corresponding to an input coupling grating and a third grating 104c corresponding to an output coupling grating. In another embodiment, which can be combined with other embodiments described herein, the waveguide 100 further includes a second grating 104b. The second grating 104b corresponds to a pupil expansion grating or a fold grating. A cutline 106 is superimposed onto the view of the waveguide 100 in FIG. 1A. In some embodiments, the cutline 106 may correspond to cross-sectional views of FIGS. 1B and 1C.

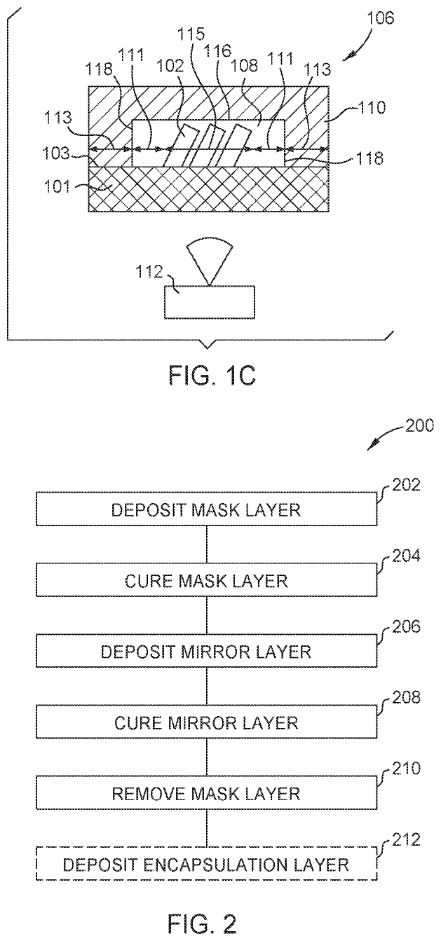

FIG. 1B is a cross-sectional view of one embodiment of waveguide 100. The cross-sectional view may correspond to the cutline 106 of FIG. 1A. The cutline 106 corresponds to a grating 104, such as the first grating 104a. Embodiments described herein may be applied at the first grating 104a of an input coupler grating, the second grating 104b of a pupil expansion grating, the third grating 104c of an output coupler grating, or combinations thereof. The waveguide 100 of FIG. 1B includes structures 102. of substrate 101. In some embodiments, the structures 102 may be disposed over, under, or on a first surface 103 of a substrate 101, or disposed in the substrate 101. As shown in FIG. 2, the structures 102 are disposed on the first surface 103. The waveguide 100 of FIG. 1B includes a mirror layer 108 disposed on a second surface 114 of the substrate 101 opposing the first surface 103. The mirror layer 108 may be disposed opposite from a light engine 112 across the substrate 101. In some embodiments, the mirror layer 108 material may include silver (Ag). The mirror layer 108 is on adjacent regions 111 of the second surface 114 adjacent to the structures 102 of the grating 104. The regions 113 of the surface surrounding the adjacent regions 111 and the gratings 104 do not include the mirror layer 108. That is, the mirror layer is only on the adjacent regions 111 and an opposing area 115 of the grating 104. In some cases, the waveguide 100 of FIG. 1B optionally includes an encapsulation layer 110. The encapsulation layer 110 may be disposed over the mirror layer 108, such that the encapsulation layer 110 is disposed on a bottom surface 116 and each of the side surfaces 118 of the mirror layer 108. The encapsulation layer 110 may extend from the mirror layer 108 to be disposed over a portion of the bottom surface 114 of the substrate 101.

FIG. 1C is a cross-sectional view of one embodiment of waveguide 100. The cross-sectional view may correspond to the cutline 106 of FIG. 1A. The cutline 106 corresponds to a grating 104, such as the first grating 104a. Embodiments described herein may be applied at the first grating 104a of an input coupler grating, the second grating 104b of a pupil expansion grating, the third grating 104c of an output coupler grating, or combinations thereof. The waveguide 100 of FIG. 1C includes structures 102 disposed on the first surface 103 of substrate 101. The mirror layer 108 is on adjacent regions 111 of the second surface 114 adjacent to the structures 102 of the grating 104. The regions 113 of the surface surrounding the adjacent regions 111 and the gratings 104 do not include the mirror layer 108. That is, the mirror layer 108 is only on the adjacent regions 111 and an opposing area 115 of the grating 104. The waveguide 100 of FIG. 1C includes a mirror layer 108 disposed above substrate 101, on the top first surface 103 of the substrate 101. The mirror layer may be disposed opposite from a light engine 112 across the substrate 101. In some cases, the waveguide 100 of FIG. 1C optionally includes an encapsulation layer 110. The encapsulation layer 110 may be disposed over the mirror layer 108, such that the encapsulation layer 110 is disposed on a top surface 120 and each of the side surfaces 118 of the mirror layer 108. The encapsulation layer 110 may extend from the mirror layer 108 to be disposed over a portion of the top first surface 103 of the substrate 101.

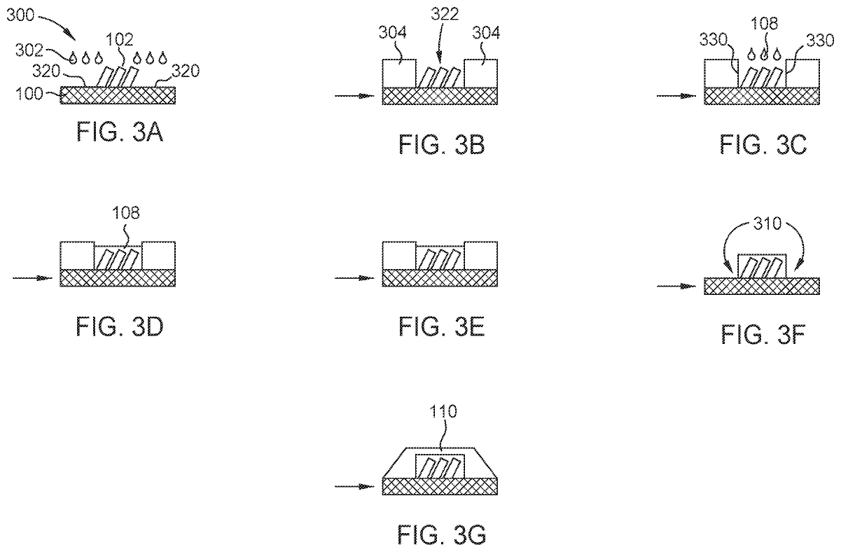

FIG. 2 depicts a flow diagram of a method 200 for forming a waveguide (e.g., waveguide 100, waveguide 300), according to one or more embodiments of the present disclosure. FIGS. 3A-3G illustrate cross-sectional schematic views of a waveguide 300 during a method 200, in accordance with one or more embodiments of the present disclosure. It should be understood that FIGS. 3A-3G illustrate only partial schematic views of waveguide 300, and the waveguide may contain any number of features and additional materials having aspects illustrated in the figures. It should also be noted that although the method 200 illustrated in FIG. 2 is described sequentially, other process sequences that include one or more operations that have been omitted and/or added, and/or have been rearranged in another desirable order, fall within the scope of the embodiments of the disclosure provided herein. In some embodiments, the waveguide 300 of FIGS. 3A-3G may be understood with reference to waveguide 100. In other embodiments, waveguide 300 may be understood independent from waveguide 100.

FIG. 3A depicts the waveguide 300 at operation 202. At operation 202, as shown in FIG. 3A. A mask layer 202 is deposited onto the substrate 101. In some embodiments, the mask layer 302 is deposited on only some portions 320 of the substrate. In some embodiments, the mask layer 302 may be deposited at operation 202 by way of inkjet deposition processes. Inkjet deposition processes may have a viscosity of about 1 cP or more to about 100 cP or less, and a surface tension of about 20 mN/m or more to about 60 mN/m or less. In some embodiments, the mask layer 302 may be deposited at operation 202 by way of screen printing deposition processes. Inkjet deposition processes may have a viscosity of about 10 cP or more to about 100,00 cP or less, and a surface tension of about 20 mN/m or more to about 60 mN/m or less.

In some embodiments, the mask layer 302 may be a water soluble mask. The water soluble mask may include a polymer component, a photo curable component, a solvent, and an additive. The polymer component of the water soluble solution includes, but is not limited to, polyvinylpyrrolidone (PVP), polyvinylpyrrolidone-co-polyvinylalcohol, polypropylene glycol, partially hydrolyzed polyvinyl acetate, or combinations thereof.

The photo curable component includes, but is not limited to, a monomer, a crosslinker, oligomer, photoinitiator, or a combination thereof. The monomer includes, but is not limited to, such as water soluble (meth)acrylates, epoxy, or combinations thereof. The crosslinker includes, but is not limited to, water soluble multi-functional (meth)acrylates or epoxy, or combinations thereof. The oligomer includes, but is not limited to, water soluble (meth)acrylates, epoxy functionalized oliogmers, or combinations thereof. The photoinitiator includes, but is not limited to, photoinitiators that can generate radicals and/or protons upon exposure to UV and/or visible light.

A solvent of the water soluble mask, which may be diluted then vaporize during baking. The solvent may include, but is not limited to, any organic solvents based on ester, ether, and alcohol whose boiling point is lower than about 250 C or more to about 350 C or less, such as about 300 C at about 0.5 at or more to about 1.5 atm or less, such as 1 atm. The solvent may include, but is not limited to, any mixture of an organic solvent with H₂O, such as a mixture with an H₂O content range from about 0% to about 80%. Such organic solvents may include, but are not limited to, DPGME(34590-94-8), DPGBE(29911-28-2), TPGME(25498-49-1), DPGPE(29911-27-1), DPGDME(111109-77-4), TPGBE(55934-93-5), PGBE(5131-66-8), DEGME(111-77-3), DEGEE(111-90-0), TEGME(112-35-6), PGME(107-98-2), PGPE(1569-1-3), PGMEA(108-65-6), DPGMEA(88917-22-0), ethanol(64-17-5), methanol(67-56-1), isopropanol(67-63-0), 1-butanol(71-36-3), 2-butanol(78-92-2), 1-pentanol (71-41-0), 2-pentanol(6032-29-7), 3-pentanol(584-2-1), 1-hexanol (111-27-3), 2-hexanol(626-93-7), 3-hexanol(623-37-0), butyl acetate(123-86-4), butyl lactate(138-22-7), or combinations thereof.

An additive includes surfactants, polymers, or combinations thereof. The surfactants are capable of tuning surface tension. The polymers can tune the viscosity of formulation.

In some embodiments, the mask layer 302 may be an ash-able mask. The ash-able mask includes, but is not limited to, epoxy, polystyrene, PMMA, Novolac resin, PVP, or combinations thereof.

The photo curable component includes, but is not limited to, a monomer, a crosslinker, oligomer, photoinitiator, or a combination thereof. The monomer includes, but is not limited to, such as water soluble (meth)acrylates, epoxy, or combinations thereof. The crosslinker includes, but is not limited to, water soluble multi-functional (meth)acrylates or epoxy, or combinations thereof. The oligomer includes, but is not limited to, water soluble (meth)acrylates, epoxy functionalized oliogmers, or combinations thereof. The photoinitiator includes, but is not limited to, photoinitiators that can generate radicals and/or protons upon exposure to UV and/or visible light.

A solvent of the water soluble mask, which may be diluted then vaporize during baking. The solvent may include, but is not limited to, any organic solvents based on ester, ether, and alcohol whose boiling point is lower than about 250 C or more to about 350 C or less, such as about 300 C at about 0.5 at or more to about 1.5 atm or less, such as 1 atm. The solvent may include, but is not limited to, any mixture of an organic solvent with H₂O, such as a mixture with an H₂O content range from about 0% to about 80%. Such organic solvents may include, but are not limited to, DPGME(34590-94-8), DPGBE(29911-28-2), TPGME(25498-49-1), DPGPE(29911-27-1), DPGDME(111109-77-4), TPGBE(55934-93-5), PGBE(5131-66-8), DEGME(111-77-3), DEGEE(111-90-0), TEGME(112-35-6), PGME(107-98-2), PGPE(1569-1-3), PGMEA(108-65-6), DPGMEA(88917-22-0), ethanol(64-17-5), methanol(67-56-1), isopropanol(67-63-0), 1-butanol(71-36-3), 2-butanol(78-92-2), 1-pentanol (71-41-0), 2-pentanol(6032-29-7), 3-pentanol(584-2-1), 1-hexanol (111-27-3), 2-hexanol(626-93-7), 3-hexanol(623-37-0), butyl acetate(123-86-4), butyl lactate(138-22-7), or combinations thereof.

An additive includes surfactants, polymers, or combinations thereof. The surfactants are capable of tuning surface tension. The polymers can tune the viscosity of formulation.

In some embodiments, the mask layer 302 material may be modifiable, such that the surface tension, viscosity, and barometric pressure of a system may be tuned to suit certain use cases.

FIG. 3B depicts the waveguide 300 at operation 204. At operation 204, as shown in FIG. 3B, the mask layer 302 is then cured, forming a trench feature 322 on the surface of the substrate 101. In some embodiments, the mask layer 302 may be cured using a thermal or an ultra-violent curing process. In some embodiments, structures 102 may be formed below the substrate 101, opposite the mask layer 302. In other embodiments not shown, structures 102 may be formed above the substrate 101, over the mask layer 302.

Implementing a mask layer 302 on portions 320 of the substrate allow for deposition of a mirror layer 108 at operation 206 of FIG. 2, as illustrated in the waveguide 300 of FIGS. 3C and 3D. Specifically, the mask layer 302 allows the mirror layer 108 to be deposited within the trench feature 322 and along a desired deposition edge limit 330. The mask layer 302 achieves this by blocking the mirror layer 108 from extending beyond the desired deposition edge limit 330 during initial deposition (as shown in FIG. 3C) and optional reflow (as shown in FIG. 3D). In effect, the mask layer 302 may operate as a wall to constrain the reflow of mirror layer 108 material.

In some embodiments, the mirror layer 108 material may include silver (Ag). In some embodiments, the mirror layer 108 may be deposited at operation 206 by way of inkjet deposition processes. Inkjet deposition processes may have a viscosity of about 1 cP or more to about 100 cP or less, and a surface tension of about 20 mN/m or more to about 60 mN/m or less. In some embodiments, the mirror layer 108 may be deposited at operation 202 by way of screen printing deposition processes. Inkjet deposition processes may have a viscosity of about 10 cP or more to about 100,00 cP or less, and a surface tension of about 20 mN/m or more to about 60 mN/m or less. In some embodiments, the mirror layer 108 may be disposed over or opposite the first grating 104a corresponding to the input coupling grating, as illustrated in FIG. 1A. In some embodiments, the mirror layer 108 may have a width of about 1 μm. In some embodiments, the mirror layer 108 may have a height of about 20 nm or more to about 20 μm or less, such as about 5 μm or more to about 10 μm or less. In some embodiments, the thickness of the mirror layer 108 may be substantially uniform in a lateral direction, substantially non-uniform in a lateral direction, or substantially semi-uniform in a lateral direction.

FIG. 3E depicts the waveguide 300 at operation 208. In some embodiments, the mirror layer 108 may be cured using a thermal or an ultra-violent curing process. In some embodiments, structures 102 may be formed below the substrate 101, opposite the mirror layer 108. In other embodiments not shown, structures 102 may be formed above the substrate 101, over the mirror layer 108.

FIG. 3F depicts the waveguide 300 at operation 210. At operation 210, the mask layer 302 is removed from the surface of the substrate 101. In some embodiments, the mask layer 302 may be removed using a washable process, where the mask layer 302 is water soluble and is dissolved when the substrate 101 is exposed to an aqueous solution. In some embodiments, the mask layer 302 may be removed using an ashing process, such as a plasma ashing process, where the mask layer 302 is etched away as a result of physical exposure to a radical species.

FIG. 3G depicts the waveguide 300 at optional operation 212. At operation 210, an encapsulation layer 110 is deposited over the mirror layer 108. The encapsulation layer 110 may be disposed over the mirror layer 108 in a manner similar to the encapsulation layer 110 deposition described in FIGS. 1B and 1C. In some embodiments, the encapsulation layer 110 may be deposited at operation 212 by way of inkjet deposition processes. Inkjet deposition processes may have a viscosity of about 1 cP or more to about 100 cP or less, and a surface tension of about 20 mN/m or more to about 60 mN/m or less. In some embodiments, the mask layer 302 may be deposited at operation 202 by way of screen printing deposition processes. Inkjet deposition processes may have a viscosity of about 10 cP or more to about 100,00 cP or less, and a surface tension of about 20 mN/m or more to about 60 mN/m or less.

While the foregoing is directed to embodiments of the present disclosure, other and further embodiments of the disclosure may be devised without departing from the basic scope thereof, and the scope thereof is determined by the claims that follow.

What is claimed is:

1. A method for forming a device, comprising:
depositing a mask layer on a first portion of a surface, the mask layer forming a feature over the surface;
depositing the mirror layer on the second portion of the surface within the feature; and
removing the mask layer from the surface.

2. The method of claim 1, further comprising:
curing the mask layer using thermal radiation or ultra-violet radiation; and
curing the mirror layer using thermal radiation or ultra-violet radiation.

3. The method of claim 1, further comprising reflowing the mirror layer over the second portion of the surface.

4. The method of claim 1, wherein depositing the mask layer on the first portion of the surface comprises depositing the mask layer using an inkjet deposition process or a screen printing deposition process.

5. The method of claim 1, wherein depositing the mirror layer on the second portion of the surface comprises depositing the mirror layer using an inkjet deposition process or a screen printing deposition process.

6. The method of claim 1, wherein removing the mask layer comprises dissolving the mask layer in an aqueous solution or etching the mask layer using a radical species.

7. The method of claim 1, wherein the mirror layer comprises at least a silver (Ag) material.

8. The method of claim 1, wherein the surface is disposed away from a light engine.

9. A mask layer, comprising:
a composition disposed on a portion of a surface, the composition capable of forming a feature over the surface, the composition comprising:
an organic polymer;
a photo curable component;
a solvent; and
additives.

10. The mask layer of claim 9, wherein the composition is water soluble.

11. The mask layer of claim 10, wherein the organic polymer comprises at least one of:
polyvinylpyrrolidone (PVP), a copolymer of PVP, a block copolymer, a random or alternative copolymer, polyvinylpyrrolidone-co-polyvinylalcohol, or copovidone.

12. The mask layer of claim 9, wherein the composition is ash-able.

13. The mask layer of claim 12, wherein the organic polymer comprises at least one of:
an epoxy, a derivative of the epoxy, polystyrene, a derivative of the polystyrene, polymethyl methacrylate (PMMA), a derivative of the PMMA, Novolac resin, a derivative of the Novolac resin, or polyvinylpyrrolidone (PVP).

14. The mask layer of claim 9, wherein the photo curable component comprises at least one of:
monomers, water soluble (meth)acrylates, epoxy, crosslinkers, water soluble multi-functional (meth)acrylates, oligomers, functionalized oliogmers, or photoinitiators.

15. The mask layer of claim 9, wherein the solvent comprises at least one of: DPGME(34590-94-8), DPGBE(29911-28-2), TPGME(25498-49-1), DPGPE(29911-27-1), DPGDME(111109-77-4), TPGBE(55934-93-5), PGBE(5131-66-8), DEGME(111-77-3), DEGEE(111-90-0), TEGME(112-35-6), PGME(107-98-2), PGPE(1569-1-3 ), PGMEA(108-65-6), DPGMEA(88917-22-0), ethanol(64-17-5), methanol(67-56-1), isopropanol(67-63-0), 1-butanol(71-36-3), 2-butanol(78-92-2), 1-pentanol (71-41-0), 2-pentanol(6032-29-7), 3-pentanol(584-2-1), 1-hexanol (111-27-3), 2-hexanol(626-93-7), 3-hexanol(623-37-0), butyl acetate(123-86-4), or butyl lactate(138-22-7).

16. The mask layer of claim 9, wherein the additives comprise at least one of:
surfactants capable of tuning a surface tension value of the composition; and
polymers capable of tuning a vicosity value of the composition.

17. A device, comprising:
a mask layer deposited on a first portion of a surface, the mask layer forming a feature over the surface; and
the mirror layer deposited on the second portion of the surface within the feature.

18. The device of claim 17, wherein the mirror layer is deposited over or substantially opposite from a plurality of gratings.

19. The device of claim 17, wherein the surface is disposed substantially away from a light engine.

20. The device of claim 17, wherein the mirror layer comprises at least a silver (Ag) material.
